(19) United States
(12) Patent Application Publication
(10) Pub. No.: US 2023/0378730 A1
(43) Pub. Date: Nov. 23, 2023

(54) MOUNTING BRACKET FOR DEPTH-ADJUSTABLE BOX AND BOX ASSEMBLY INCLUDING THE SAME

(71) Applicant: Eaton Intelligent Power Limited, Dublin (IE)

(72) Inventor: Martin L. Witherbee, Godfrey, IL (US)

(73) Assignee: Eaton Intelligent Power Limited, Dulbin (IE)

(21) Appl. No.: 18/320,661

(22) Filed: May 19, 2023

Related U.S. Application Data
(60) Provisional application No. 63/365,087, filed on May 20, 2022.

(51) Int. Cl. H02G 3/08; F16M 13/02

(52) U.S. Cl. CPC H02G 3/081; F16M 13/022

(57) ABSTRACT

The present disclosure provides an adjustable-depth junction box assembly comprising a junction box, support-mounting bracket, box-mounting bracket, and at least one screw thread. The box-mounting bracket is connected to the support-mounting bracket. In some embodiments the box-mounting bracket and the support mounting bracket are integrally formed. The support-mounting has a front face that defines an opening in which the junction box is received. The box-mounting bracket includes a mounting portion. The screw thread extends through the junction box and is rotatable coupled the mounting portion of the box-mounting bracket. The screw thread is coupled such that rotation of the screw thread imparts translation of the junction box relative to the support-mounting bracket. The present disclosure further provides a box-mounting bracket assembly comprising a junction box, box-mounting bracket, and at least one screw thread.

### REFERENCE TO RELATED APPLICATION

This application claims benefit of U.S. Provisional Application No. 63/365,087, filed May 20, 2022, the contents of which are incorporated herein in their entirety.

### FIELD OF THE DISCLOSURE

The present disclosure generally relates to a mounting bracket for a depth-adjustable box and a depth-adjustable box assembly including the mounting bracket.

### BACKGROUND OF THE DISCLOSURE

In many applications, it may be useful to support electrical boxes at different depths relative to support structures, such as ceiling or wall structures of buildings. For example, in order to dispose electrical boxes of different depths to be flush with internal wall or ceiling surfaces, it may be useful to support the electrical boxes at different depths relative to a particular support structure. For example, in order to comply with requirements that a forward opening of an electrical box be flush with an interior surface of drywall or a ceiling, the electrical box may need to be secured to a support structure (e.g., a stud, support bracket, ceiling structure, etc.) at a depth that depends on the depth of the electrical box.

### SUMMARY OF THE DISCLOSURE

In general, a mounting bracket for a junction box enables the junction box to be selectively adjustable relative to the mounting bracket to adjust the relative spacing between a front of the mounting bracket and a front of the junction box.

In one aspect, the present disclosure provides an adjustable-depth junction box assembly including a junction box, a support-mounting bracket, a box-mounting bracket, and at least one screw thread. The junction box has a front face that defines an opening. The support-mounting bracket is configured to be secured to a support structure to mount the adjustable-depth junction box assembly on the support structure. The support-mounting bracket has a front face that defines an opening in which the junction box is received. The box-mounting bracket is connected to the support-mounting bracket and includes a mounting portion spaced rearward of the front face of the support-mounting bracket. The at least one screw thread extends through the junction box and is rotatable coupled to the mounting portion of box-mounting bracket to secure the junction box to the box-mounting bracket. The at least one screw thread is threadably coupled to the junction box such that rotation of the at least one screw thread imparts translation of the junction box relative to the support-mounting bracket to enable selective adjustment of the front face of the junction box relative to the front face of the support-mounting bracket.

In another aspect, the disclosure provides a box-mounting bracket assembly for a support-mounting bracket that has a front face that defines an opening for receiving a junction box. The box-mounting bracket assembly includes a junction box, a box-mounting bracket, and at least one screw thread. The junction box has a front face that defines an opening. The box-mounting bracket includes a mounting portion and is configured to be selectively attached to the support-mounting bracket so that the mounting portion is spaced rearward of the front face of the support-mounting bracket. The at least one screw thread extends through the junction box and is rotatable coupled to the box-mounting bracket to secure the junction box to the box-mounting bracket. The at least one screw thread is threadably coupled to the junction box such that rotation of the at least one screw thread imparts translation of the junction box relative to the mounting portion of the box-mounting bracket.

In yet another aspect, the disclosure provides an adjustable-depth junction box assembly that includes a junction box, a support bracket, box-mounting bracket integrally formed to the support-mounting bracket, and at least one screw thread. The junction box has a front face that defines an opening. The support-mounting bracket is configured to be secured to a support structure to mount the adjustable-depth junction box assembly on the support structure. The support-mounting bracket defining an opening in which the junction box is received. The box-mounting bracket includes a mounting portion. At least one screw thread extends through the junction box and is rotatable coupled to the mounting portion of box-mounting bracket to secure the junction box to the box-mounting bracket. The at least one screw thread is threadably coupled to the junction box such that rotation of the at least one screw thread imparts translation of the junction box in a forward or rearward direction.

The details of one or more aspects of the disclosure are set forth in the accompanying drawings and the description below. Other features, objects, and advantages of the techniques described in this disclosure will be apparent from the description and drawings, and from the claims.

### BRIEF DESCRIPTION OF THE DRAWINGS

FIG. 1 is a front perspective of a first embodiment of a box assembly mounted on a wall stud, the box assembly including a mounting bracket and a junction box.

FIG. 2 is a front perspective of the first embodiment of the box assembly mounted on a bracket between two wall studs.

FIG. 3 is a front perspective of the first embodiment of the box assembly mounted on a ceiling bracket.

FIG. 4 is a rear perspective of the first embodiment of the box assembly.

FIG. 5 is a right elevation of the first embodiment of the box assembly.

FIG. 6 is a section of the first embodiment of the box assembly.

FIG. 7 is a rear perspective of the mounting bracket of the first embodiment of the box assembly.

FIG. 8 is an exploded view of FIG. 7.

FIG. 9 is a right elevation of a box-mounting bracket of the mounting bracket of the first embodiment of the box assembly.

FIG. 10 is a front perspective of a similar iteration of a box assembly similar to FIG. 1 but including a second type of box.

FIG. 11 is a rear perspective of the box assembly of FIG. 10.

FIG. 12 is a top plan view of the first embodiment of the box assembly.

FIG. 13 is a front perspective of a second embodiment of a box assembly mounted on a wall stud.

FIG. 14 is a rear perspective of the second embodiment of the box assembly.

FIG. 15 is an exploded view of FIG. 14.

FIG. 16 is a front perspective of a similar iteration of a box assembly similar to FIG. 13 but including a second type of box.

FIG. 17 is a rear perspective of the box assembly of FIG. 16.

FIG. 18 is a rear perspective of a third embodiment of a box assembly.

FIG. 19 is a rear perspective of a similar iteration of the box assembly similar to the third embodiment but including a different type of box.

FIG. 20 is a front perspective of a fourth embodiment of a box assembly.

FIG. 21 is a rear perspective of the fourth embodiment of the box assembly.

FIG. 22 is a rear perspective of a similar iteration of a box assembly similar to FIG. 20 but including a second type of box.

FIG. 23 is a front perspective of a fifth embodiment of a box assembly.

FIG. 24 is a rear perspective of the fifth embodiment of the box assembly.

FIG. 25 is similar to FIG. 24 except a box-mounting bracket is rotated 90 degrees.

FIG. 26 is a rear perspective of a similar iteration similar to the fifth embodiment except including a different type of box.

FIG. 27 is a rear perspective similar to FIG. 26 except a box-mounting bracket is rotated 90 degrees.

FIG. 28A is a front perspective of a seventh embodiment of a box assembly.

FIG. 28B is a rear perspective of the seventh embodiment of the box assembly.

FIG. 29 is a front perspective of an eighth embodiment of a box assembly.

FIG. 30 is a rear perspective of the eighth embodiment of the box assembly.

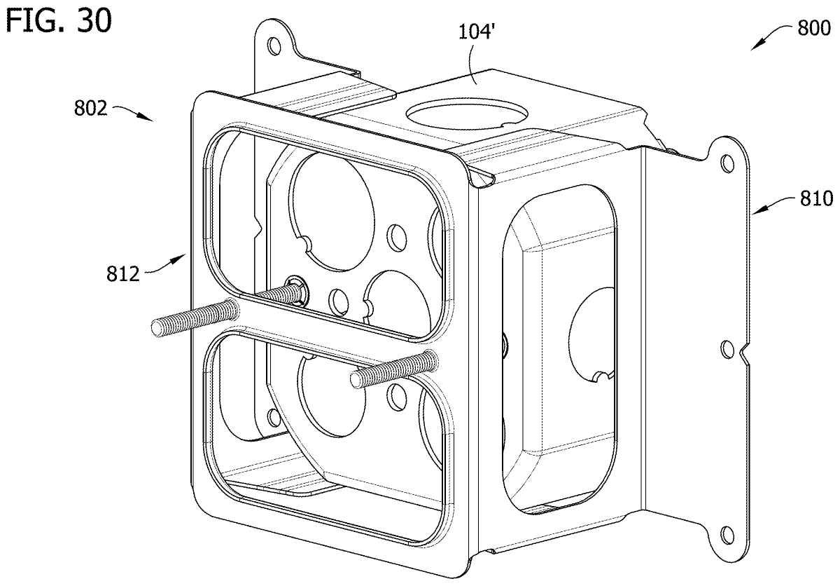

FIG. 31 is a rear perspective of a ninth embodiment of a box assembly.

FIG. 32 is a rear perspective similar to the ninth embodiment except an adaptor and a second type of box are secured to a mounting bracket of the box assembly.

FIG. 33 is a front perspective of a tenth embodiment of a box assembly.

FIG. 34 is a front perspective of a mounting bracket of the tenth embodiment of the box assembly.

FIG. 35 is a rear perspective of the tenth embodiment of the box assembly.

FIG. 36 is a rear perspective of a mounting bracket of the tenth embodiment of the box assembly.

FIG. 37 is a front perspective of a sixth embodiment of a box assembly.

FIG. 38 is a rear perspective of the sixth embodiment of the box assembly.

### DETAILED DESCRIPTION OF THE DISCLOSURE

In general, a depth-adjustable box assembly constructed according to the present description includes a mounting bracket and a junction box (e.g., electrical outlet box, electrical switch box, lighting box, fire control box, or the like) secured to the mounting bracket. The mounting bracket is configured (i.e., designed and constructed) for use in mounting the junction box on a structural support of a building or other structure. The box is secured to the mounting bracket such that a front face of the box relative to the mounting bracket is selectively adjustable. The mounting bracket may be configured to have different types of boxes and/or boxes of different depths secured thereto. Accordingly, in one or more embodiments, any one of a plurality of different types of boxes and/or boxes of different depths may be secured to mounting bracket, effectively making the mounting bracket modular. In addition, the mounting bracket may be configured to be selectively mounted on different types of structural supports and in different ways.

Unless specified or limited otherwise, the terms “mounted,” “connected,” “supported,” “secured,” and “coupled” and variations thereof are used broadly and encompass both direct and indirect mountings, connections, supports, and couplings. Also as used herein, unless otherwise specified or limited, directional terms are presented only with regard to the particular embodiment and perspective described. For example, reference to features or directions as “horizontal,” “vertical,” “front,” “rear,” “left,” “right,” and so on are generally made with reference to a particular figure or example and are not necessarily indicative of an absolute orientation or direction. However, relative directional terms for a particular embodiment may generally apply to alternative orientations of that embodiment. For example, “front” and “rear” directions or features (or “right” and “left” directions or features, and so on) may be generally understood to indicate relatively opposite directions or features.

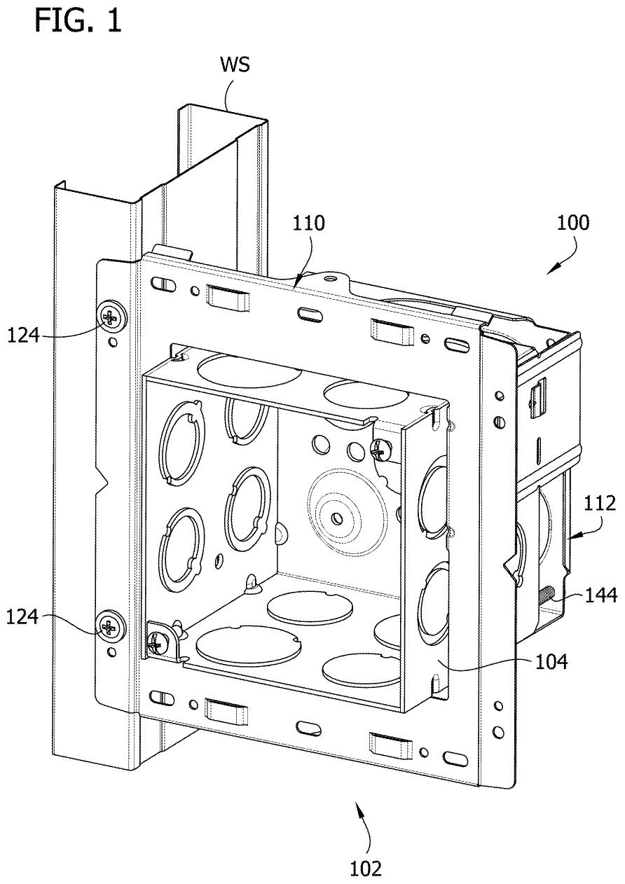

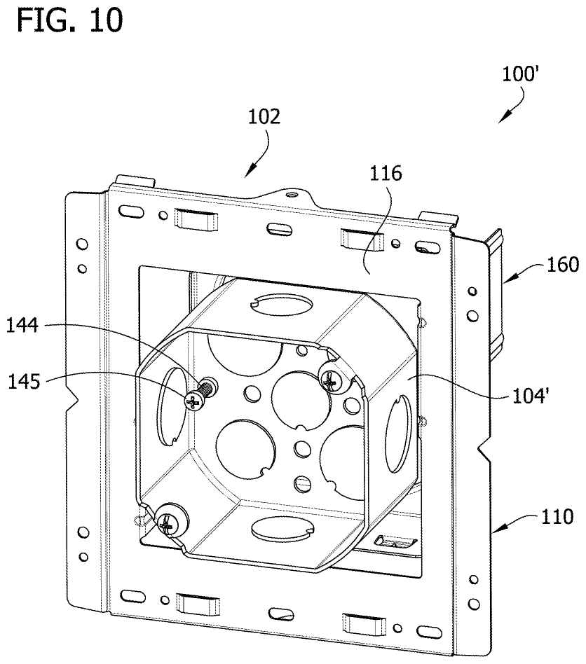

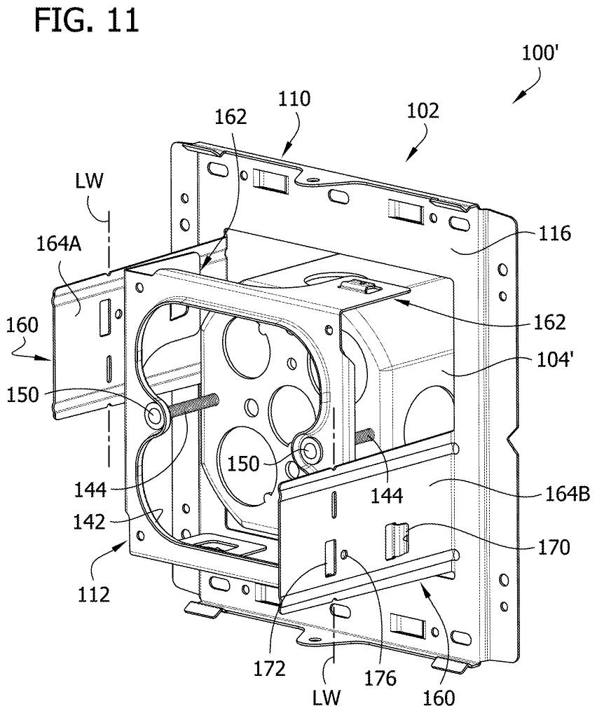

Referring now to FIG. 1, in one embodiment a depth-adjustable box assembly is generally indicated at reference numeral 100. The box assembly 100 generally includes a mounting bracket, generally indicated at 102, and a junction box 104 secured to the mounting bracket. In the embodiment shown in FIG. 1, the junction box 104 is a square box (e.g., 4x4 in box for fire controls). As shown in FIGS. 10 and 11, a different type of junction box 104′ (e.g., an octagonal box) is secured to the same type of mounting bracket 102 to form a second embodiment of a depth-adjustable box assembly, generally indicated at reference numeral 100′. In this example, the junction box 104′ has a depth less than the depth of the junction box 104, and the shapes of the boxes are different, thereby the boxes are of different types and depths, although it is understood that the boxes may be of the same type but different depths or the boxes may be of different types but the same depth. Accordingly, the mounting bracket 102 is configured (i.e., designed and constructed) to have different types of junction boxes and/or boxes of different depths secured thereto.

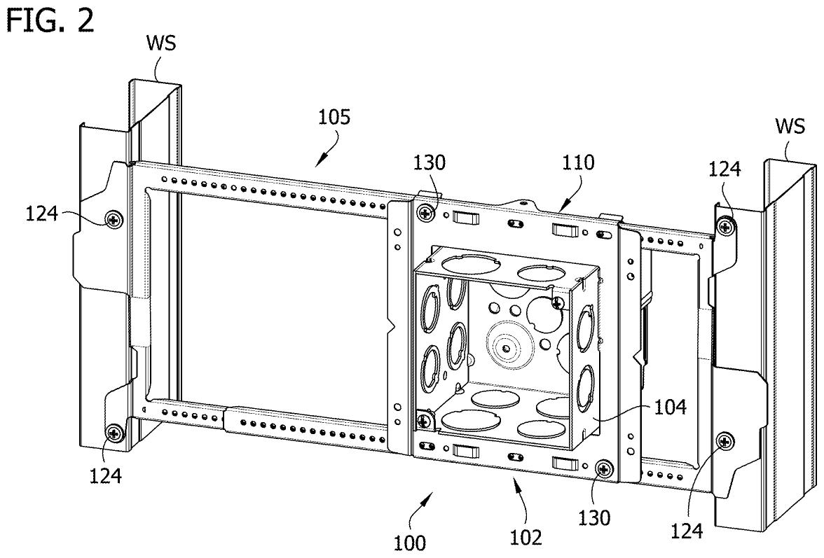

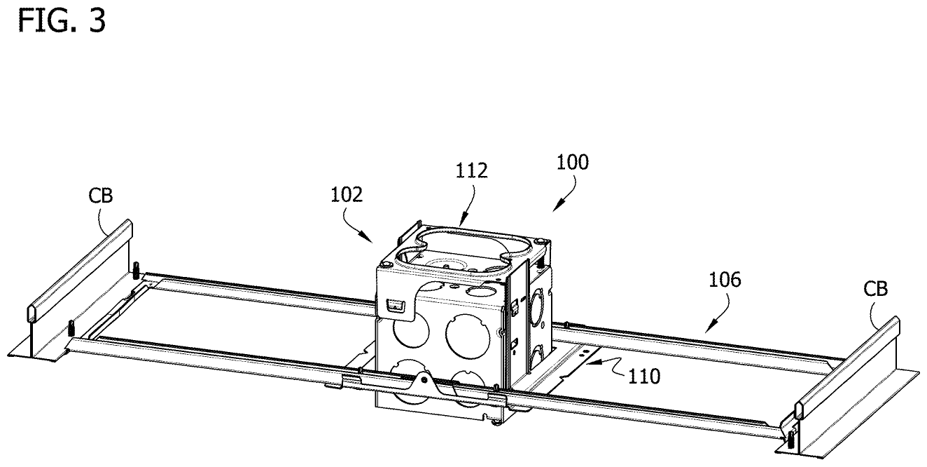

The mounting bracket 102 is configured (i.e., designed and constructed) to be mounted on a structural support (e.g., wall stud, strut, beam, ceiling hanger, or the like) of a building or other structure. In non-limiting examples, as explained in more detail below, the depth-adjustable box assembly 100, 100′ is selectively mountable directly on i) a wall stud WS (FIG. 1); ii) or a stud-mounting bracket, generally indicated at 105, which is directly mounted on adjacent wall studs (FIG. 2); or iii) a ceiling beam CB mounting bracket, generally indicated at 106, which is directly mounted on adjacent ceiling beams (FIG. 3); among others. The box assembly 100, 100′ may be configured to be mounted on structural supports in other ways and on other types of structural supports of a building or other structure.

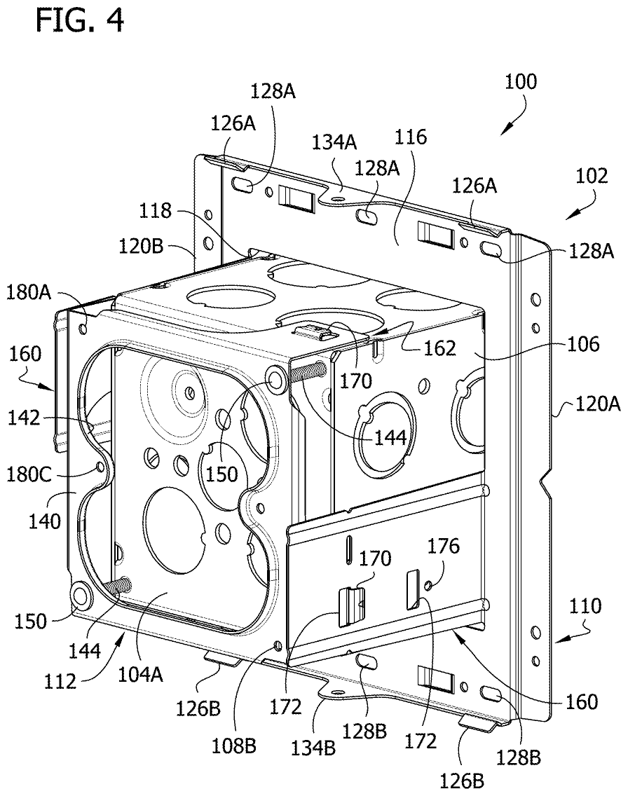

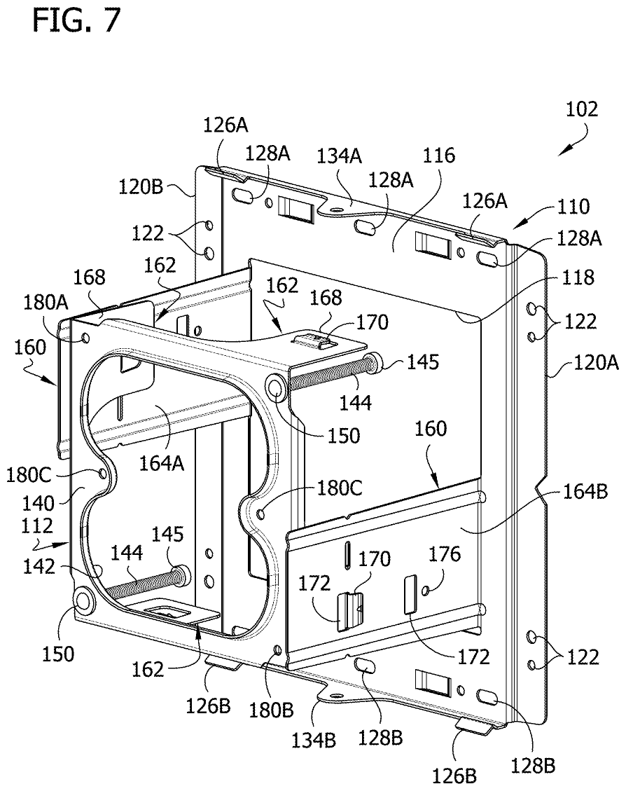

Referring to FIGS. 4-8, the mounting bracket 102 includes a support-mounting bracket, generally indicated at 110, and a box-mounting bracket, generally indicated at 112, connected to the support-mounting bracket. As explained below, in the illustrated embodiment, the support-mounting bracket 110 and the box-mounting bracket 112 are formed separately and subsequently secured to one another to form the mounting bracket 102. In one or more other embodiments, the support-mounting bracket 110 and the box-mounting bracket 112 may be integrally formed as a single, one-piece component.

The illustrated support-mounting bracket 110 includes a front plate 116 defining a box opening 118 (e.g., a central box opening) configured to receive the selected junction box 104, 104′ therein. Left and right mounting flanges 120A, 120B extend laterally outward from respective left and right sides of the front plate 116. The mounting flanges 120A, 120B define fastener openings 122 for receiving fasteners 124 (FIG. 1) to secure the mounting flanges, and therefore the box assembly 100, 100′ to a structural support (e.g. a wall stud WS), such as shown in FIG. 1. Upper and lower snap-arms 126A, 126B extend rearward from respective upper and lower sides of the front plate 116. As shown in FIGS. 2 and 3, the snap-arms 126A, 126B are configured to snap-fit onto the stud-mounting bracket 105 or ceiling-beam bracket 106 to at least temporarily hold the box assembly 100 on the bracket. The front plate 116 defines upper and lower fasteners openings 128A, 128B configured to receive fasteners 130 (e.g., screws; FIG. 2) for securing the box assembly 100 to the mounting bracket 104 at a selected location. The support-mounting bracket 110 further includes upper and lower tabs 134A, 134B extending rearward and defining fastener openings configured to receive a hanger wire, for example, for securing the box assembly 100 to other types of structural supports. In other embodiments, the support-mounting bracket 110 may include other types of mounting components and/or structures suitable for securing the support mounting bracket (and the box assembly 100) to one or more types of structural supports. It is understood that in one or more embodiments the support mounting bracket 110 may include only one type of mounting component or structure suitable for mounting the support bracket.

The illustrated box-mounting bracket 112 includes a rear plate 140 (broadly, a mounting portion of the box-mounting bracket) generally opposing and spaced rearward from a back 104A of the junction box 104 and the front plate 116, whereby the back of the box is disposed between the rear plate and the front plate. The rear plate 140 defines an opening 142 to provide access to the rear of the junction box 104 (e.g., access to the knock-outs on the back 104A of the body). The junction box 104 is adjustably secured to the rear plate 140 by at least one screw thread 144 (e.g., two screw threads, as shown) or other rotation-to-translation device. The screw thread(s) 144 is threadably attached to the junction box 104 to enable relative translation via rotation of the screw thread about its axis. The screw thread(s) 144 extends through and rearward from the back 104A of the box. A head 145 of each screw thread 144 is received in the interior of the junction box 104 and are accessible by a user, such as via a driver, for rotating the screw thread. In one example, a threaded nut(s) or boss(es) 146 is attached to or otherwise provided on the junction box 104 at the back 104A thereof to enable threaded attachment of the screw thread(s) 144 to the box. The screw thread(s) may be threadably attached to the junction box 104 in other ways to enable relative translation. A rear portion of each screw thread 144 is rotatably attached to the box-mounting bracket 112 (e.g., the rear plate 140) to enable rotation of the screw thread 144 relative to the box mounting bracket 112 without relative translation. In one example, the rear end 150 of each screw thread 144 extends through an opening in the rear plate 140 and is staked or otherwise deformed to rotatably secure the screw thread to the box-mounting bracket 112. The screw thread 144 may be rotatably secured (without relative translation) to the box-mounting bracket 112 in other ways.

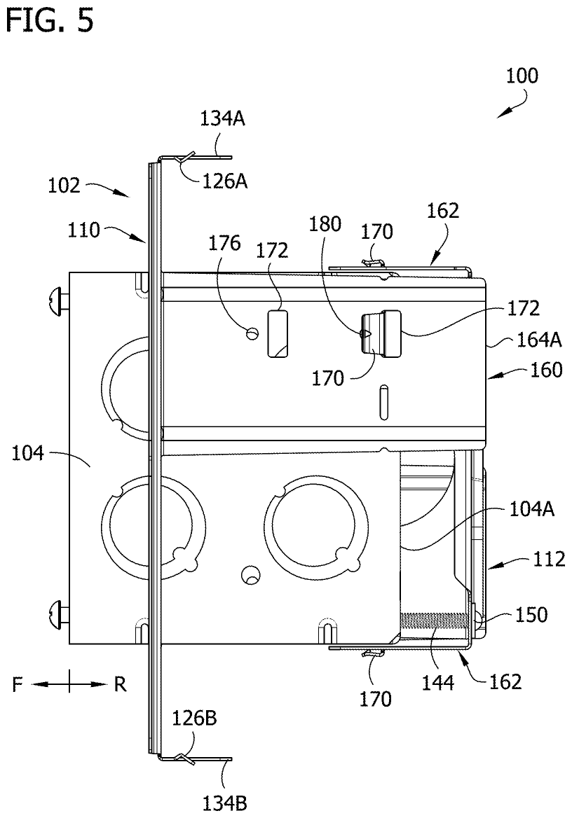

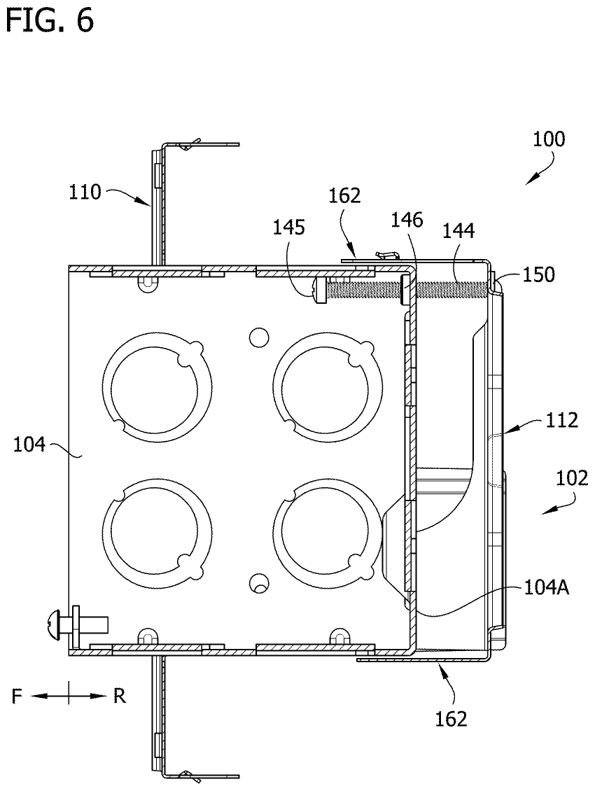

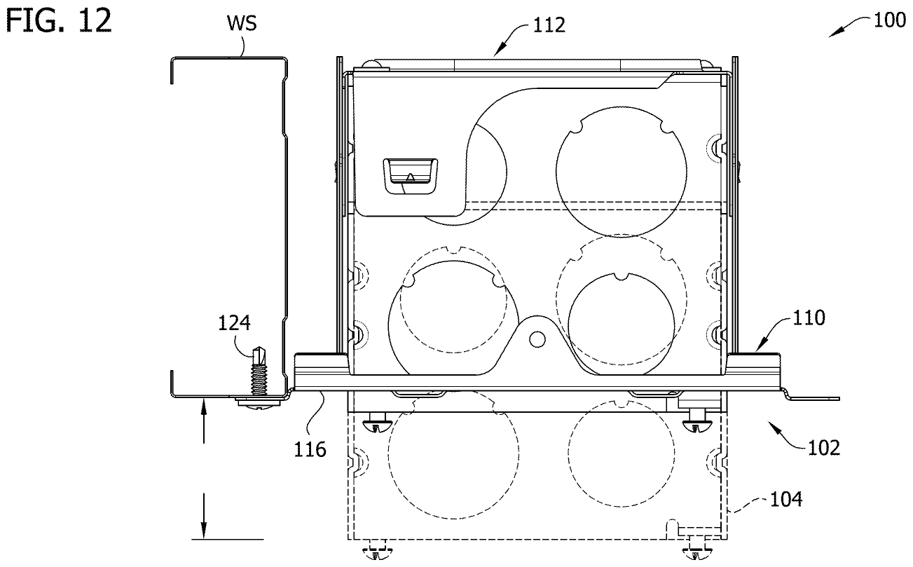

As can be understood from FIGS. 5 and 6, rotation of the screw thread(s) 144 imparts translation of the junction box 104 relative to the mounting bracket 102 in a rearward-forward direction. Referring to FIG. 12, the depth of the junction box 104 relative to the front plate 116 is selectively adjustable by the user by rotating the screw thread(s) 144. For example, the user may insert a driver or other tool into the interior of the junction box 104, 104′ and drive rotation of the screw thread(s) to impart movement of the box relative to the bracket. Through this design, the user may adjust the position of the junction box 104, 104′ after mounting the box assembly 100, 100′ on the support and after drywall or other material forming a wall, ceiling or other partition has been installed. In particular, in certain situations for example the user may adjust the junction box 104, 104′ so that the front of the box is generally coplanar with the front of the partition. Because the depth of the junction box 104, 104′ relative to the front plate 116 is adjustable through the interior of the box, the user can adjust the depth of the box after installation of the partition. Such a scenario is suitable when the box assembly 100, 100′ does not include a mud ring or other cover on the front of the junction box 104, 104′, although the adjustment of the box may be used when a mud ring or other front cover is used.

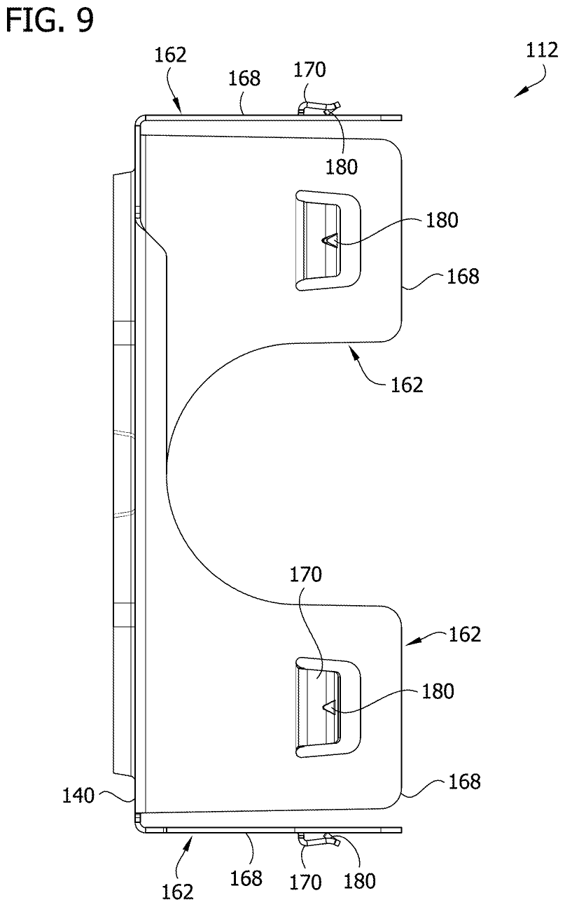

As explained above, different types of junction boxes may be used with the mounting bracket 102. The illustrated mounting bracket 102 is modular and selectively configurable in a first configuration for use with the first type of box 100 (e.g., a 4x4 in box) and a second configuration for use with the second type of box 100′ (e.g., an octagonal box). To accomplish this modularity of the mounting bracket 102, the support-mounting bracket 110 and the box-mounting bracket 112 are formed as separate components and thereafter connected to one another in either the first configuration or the second configuration, depending on the type of box to be used with the mounting bracket. The mounting bracket 102 includes mateable connectors 160, 162 configured to connect the box-mounting bracket 112 to the support-mounting bracket 110. In the illustrated embodiment, the connector 160 of the support-mounting bracket 110 includes upper and lower connector legs 164A, 164B extending rearward from the front plate 116 on either side of the box opening 118. The connector 162 of the box-mounting bracket includes a connector leg 168 extending forward from each of the four sides of the rear plate 140. Each of the connector legs 168 of the box-mounting bracket 112 includes a locking tab 170 that is receivable in slots 172 defined by the connector legs 164A, 164B of the support-mounting bracket 110. In the illustrated embodiment, each of the upper and lower connector legs 164A, 164B of the support-mounting bracket 110 defines a pair of slots 172: a first slot spaced rearward from a second slot. A locking opening 176 is adjacent each of the first and second slots 172 and is configured to receive a catch 180 (e.g., a barb; shown best in FIG. 9) extending from the locking tab 170 to form a snap-fit connection. The tabs 168 and/or the catches 180 are resiliently deflectable to provide the snap-fit connection. In one or more embodiments, the tabs 170 are configured to be selectively and resiliently bent away from the connector leg 168 to remove the catch 180 from the locking opening 176, thereby enabling a user to selectively detach the box-mounting bracket 112 (with or without the junction box 104, 104′ attached thereto) from the support-mounting bracket 110.

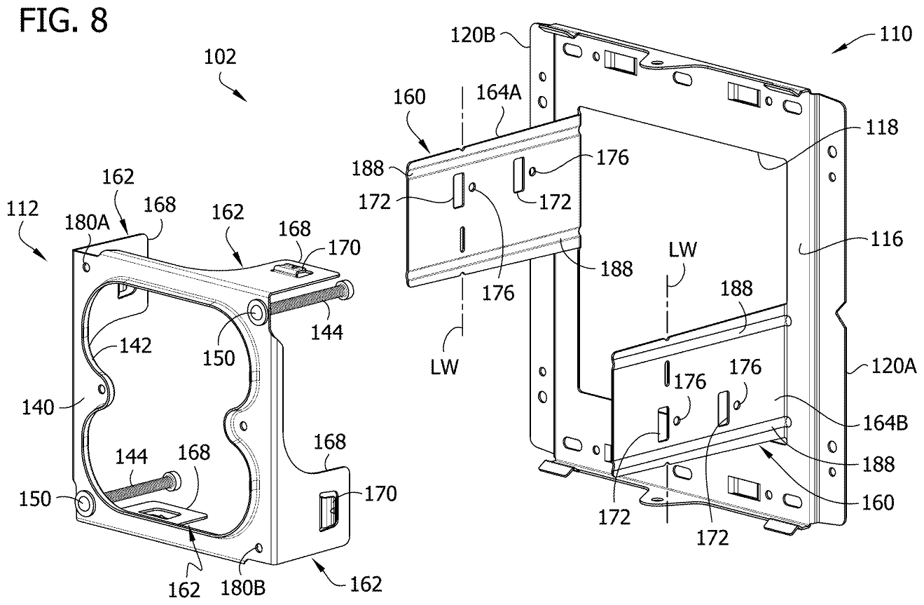

In the first configuration of the mounting bracket 102, as shown in FIGS. 4-8, two of the locking tabs 170 are received in the first slots 172 and moved in the forward direction so that the catches 180 associated with the tabs snap into the respective locking openings 176, thereby connecting the support-mounting bracket 110 and the box-mounting bracket 112. In addition, the screw threads 144 are rotatably coupled to the rear plate 140 at diagonally opposite upper and lower openings 180A, 180B extending through the rear plate 140. It is understood that the junction box 104 may be rotated 90 degrees and the screw threads 144 may be rotatable secured within the other pair of diagonally opposite openings 180A, 180B in the rear plate 140. In the second configuration of the mounting bracket 102, shown in FIGS. 10 and 11, two of the tabs 170 are received in the second slots 172 and moved in the forward direction so that the catches 180 associated with the tabs snap into the respective locking openings 176, thereby connecting the support-mounting bracket 110 and the box-mounting bracket 112. In addition, the screw threads 144 are rotatably coupled to the rear plate 140 at opposite left and right mid openings 180C in the rear plate 140. Referring to FIG. 11, although not shown, the connector legs 164A, 164B may be bent inwards at lines of weaknesses LW (e.g., defined by upper and lower notches and a slot-shaped cutout; see also FIG. 8) when the mounting bracket 102 is in the second configuration. As indicated in FIG. 8, longitudinal ribs 188 are formed on the connector legs 164A, 164B of the support-mounting bracket 110 to provide rigidity. Ribs may also be formed on the connector legs 168 of the box-mounting bracket 112.

As can be seen from the drawings, the box-mounting bracket 112 is selectively coupleable to the support-mounting bracket 110 in any one of 4 different angular positions because the box-mounting bracket includes the four connectors 162, although only two of the connectors of the box-mounting bracket are connected to the connector legs 164A, 164B of the support-mounting bracket 110 in either of the configurations. In this way, the box 100, 100′ can be rotated to any one of four angular positions that are 90 degrees offset from one another after box-mounting bracket 112 is connected to the box to connect the box-mounting bracket to the support-mounting bracket 110. Thus, the orientation of the box 100, 100′ is modular in addition to the type of box that can be used with the mounting bracket 102. It is understood that in this particular embodiment the box-mounting bracket 112 may include only two connectors 162, for example, rather than four.

As explained above, the mounting bracket 102 is modular so that the mounting bracket may be configured in either the first configuration for a first type of junction box or a second configuration for a second type of junction box (or additional configurations for additional boxes). As an example, the box assembly 100, 100′ may be assembled at a location remote from the job site and shipped to the job site as assembled. As another example, the box-mounting bracket 112 with the box 100, 100′ connected thereto with the screw threads 144 and the support-mounting bracket 110 may be shipped to the job site unassembled and then assembled at the job with the box having the desired angular orientation relative to the support-mounting bracket. As yet another example, the user may adjust the angular orientation of the box 100, 100′ after connecting the box-mounting bracket 112 to the support-mounting bracket 110 by bending the locking tabs 170 away from the connector legs 168 (such as by using one's fingers, a flat head screw driver, or pliers, etc.) so that the catches 180 exit the locking openings 176, whereby the box-mounting bracket may then be slid rearward and the tabs moved back through the slots 172 to remove the box-mounting bracket along with the attached box from the support-mounting bracket. Then, the box-mounting bracket 112 with the attached box 100, 100′ can be rotated to any of the other 3 angular positions and then reattached to the support-mounting bracket 110 in the manner described above.

The support-mounting bracket 110 may be formed from a single piece of sheet metal or from one or more components secured to one another. The openings and components of the support-mounting bracket 110 may be formed by conventional sheet metal fabricating techniques. The box-mounting bracket 112 may be formed from a single piece of sheet metal or from one or more components secured to one another. The openings and components of the box-mounting bracket 112 may be formed by conventional sheet metal fabricating techniques. Suitable sheet metal for either or both of the support-mounting bracket 110 and the box-supporting bracket 112 includes steel, aluminum, or other metal.

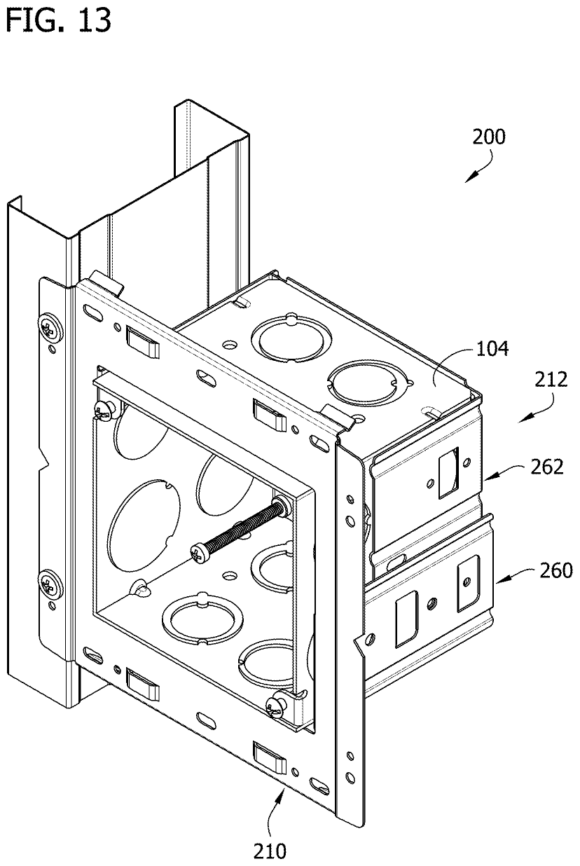

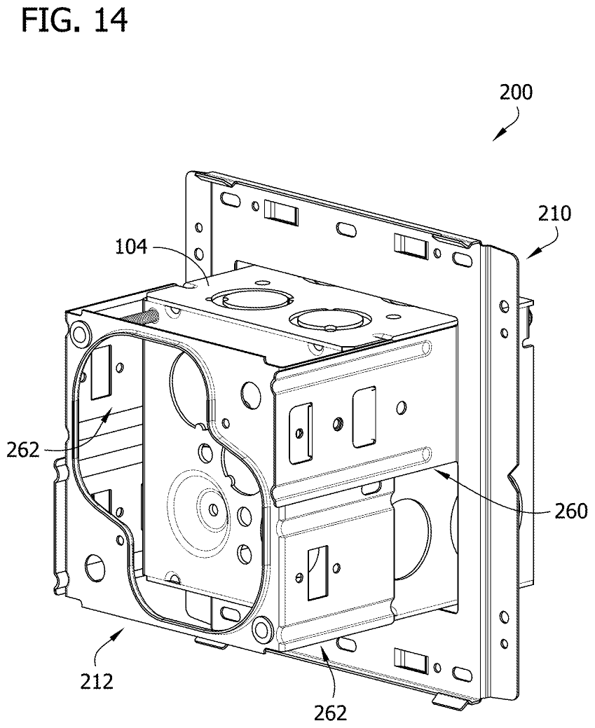

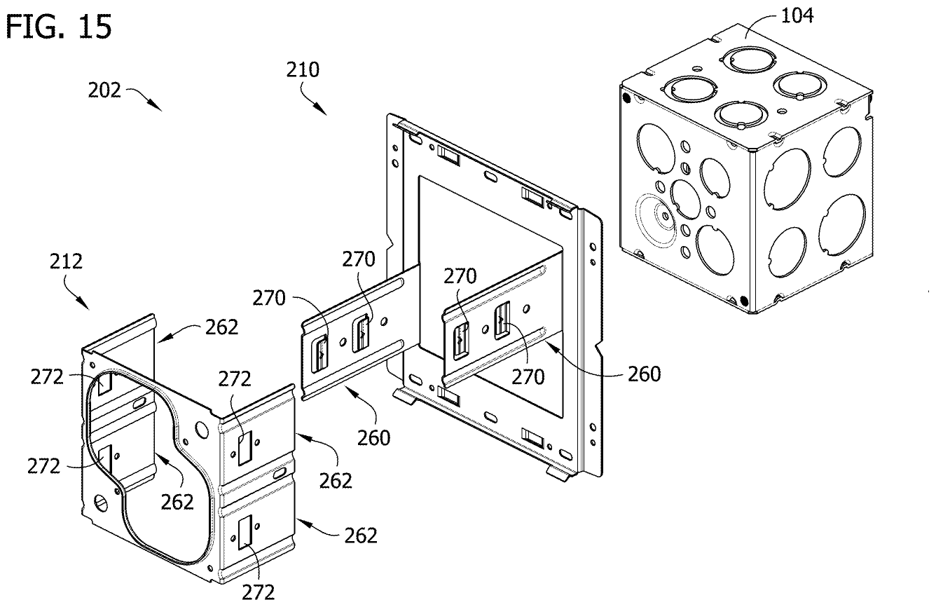

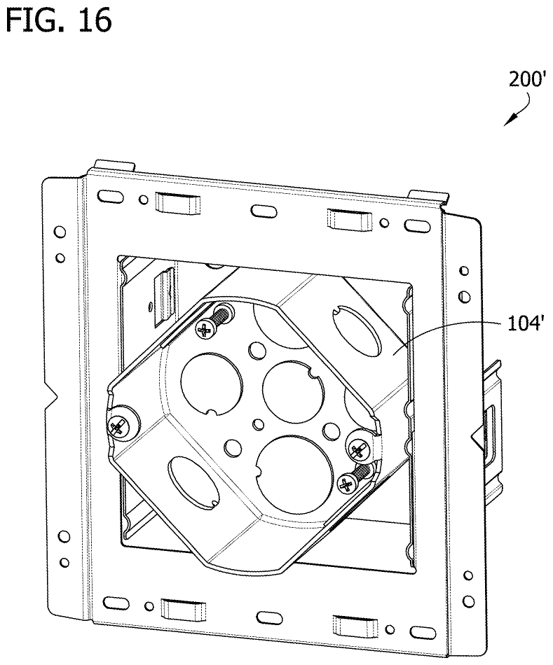

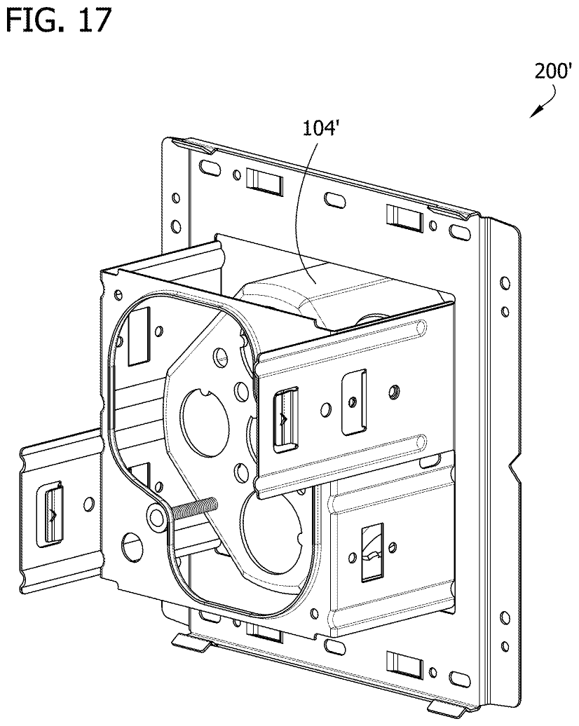

In a second embodiment of a box assembly 200 shown in FIGS. 13-15, which include the first box 104, the box-mounting bracket 212 is rotatable between 2 angular positions that are 180 degrees offset from one another. In this embodiment, the box-mounting bracket 212 includes two left connector legs 262 and two right connector legs 262, but no upper or lower connector legs. This embodiment also illustrates locking tabs 270 (which may be similar constructions as locking tabs 170) being on connector legs 260 of a support-mounting bracket 210 and slots 272 being defined by the connector legs 262 of the box-mounting bracket 212. Thus, in this embodiment each leg connector 260 of the support-mounting bracket 210 includes first and second tabs 270 that are receivable in a single slot 272 of the appropriate one of the upper and lower leg connectors 262 of the box-mounting bracket 212 to configure the mounting bracket 202 in the first configuration or the second configuration. Other than this difference, this mounting bracket 202 may be substantially the same as the first box assembly. The other teachings of the first box assembly 102 apply equally to this second box assembly 202. FIGS. 16 and 17 illustrates another embodiment of the box assembly 200′ that include the other type of box 104′ with the same mounting bracket 202.

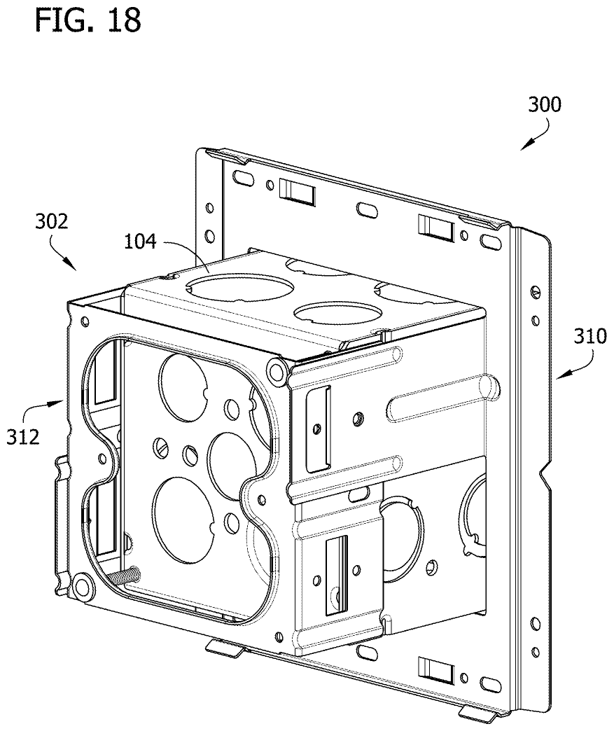

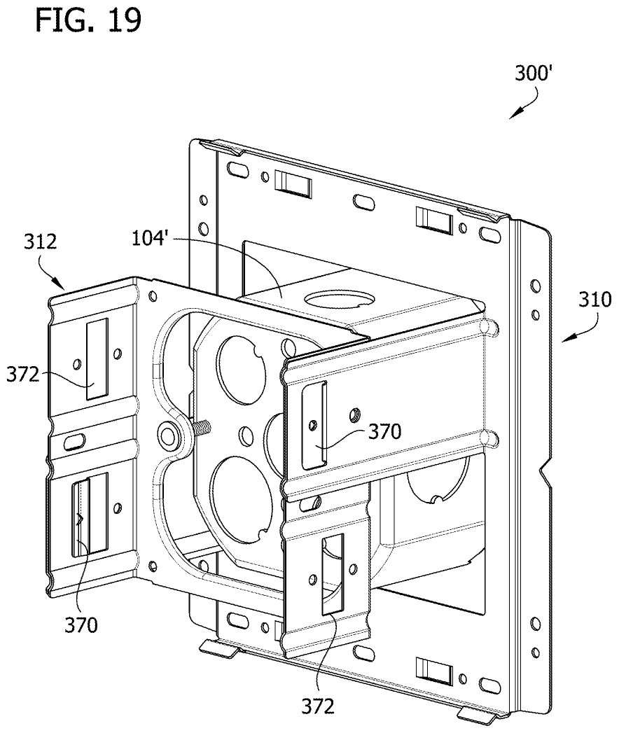

In a third embodiment of a box assembly 300, 300′ shown in FIGS. 18 and 19, a box-mounting bracket 312 is rotatable between 2 angular positions that are 180 degrees offset from one another and securable to a support-mounting bracket 310 to form a mounting bracket 302. Unlike the second embodiment, the box-mounting bracket 312 of the mounting bracket 302 is flipped in a forward-rearward direction in order to configure it between the first and second configurations. This can be seen comparing FIG. 18 to FIG. 19. Thus, the leg connectors 362, 360 includes only one locking tab 370 or slot 372.

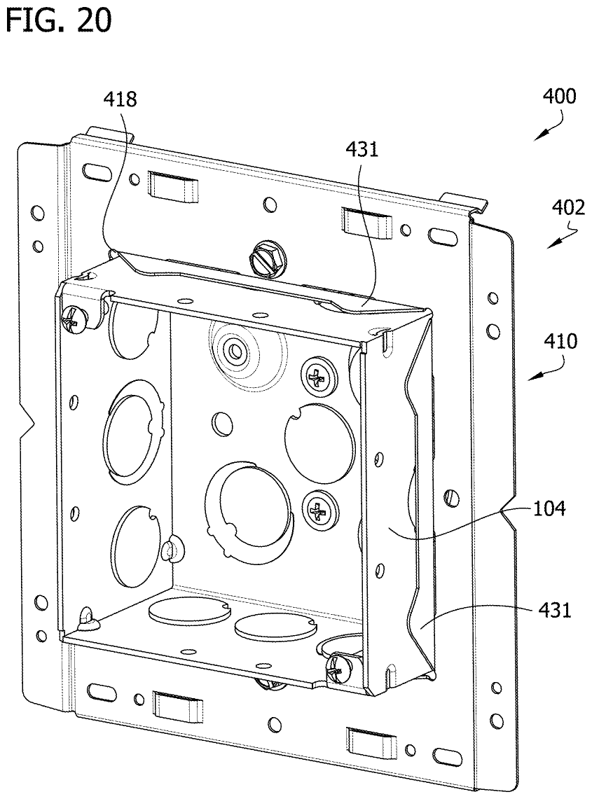

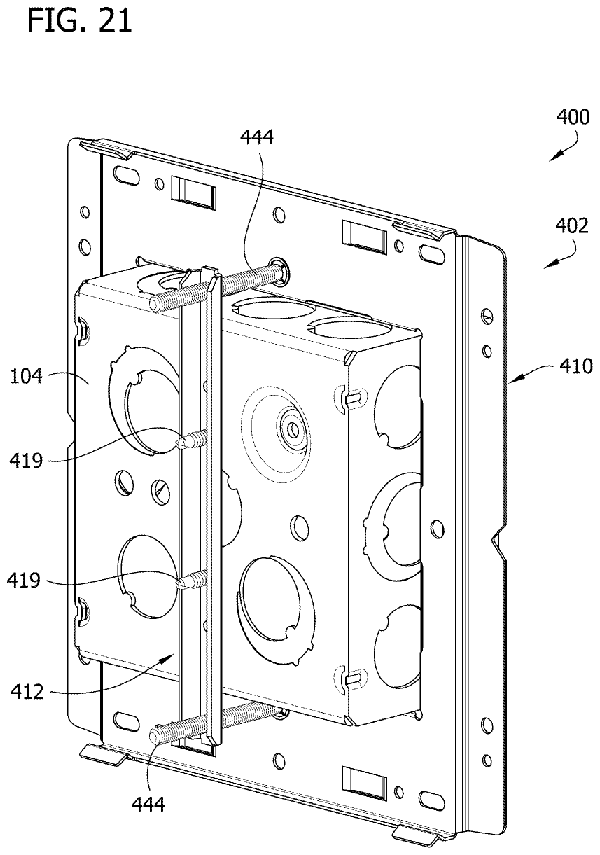

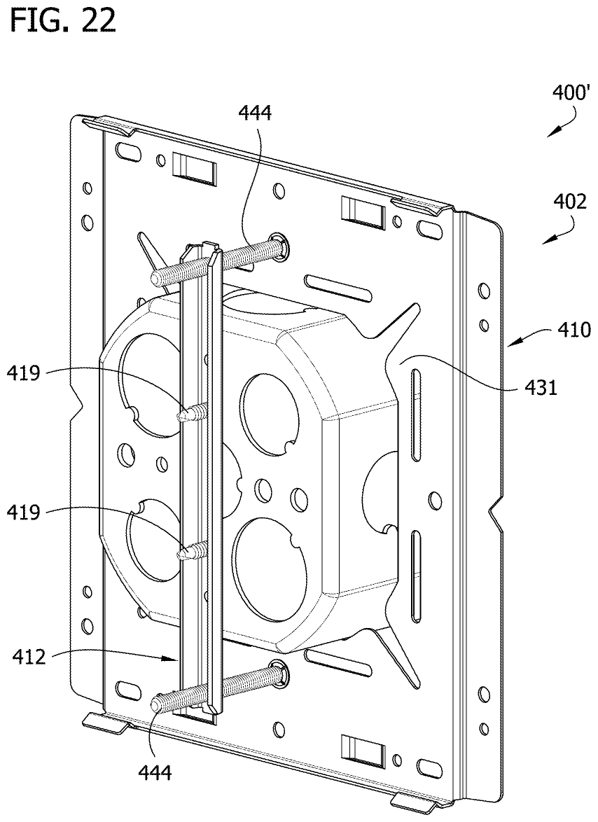

In a fourth embodiment of a box assembly 400, 400′ shown in FIGS. 20-22, a mounting bracket 402 includes a support-mounting bracket 410 and a box-mounting bracket 412 secured to the support-mounting bracket by screw threads 444. The support-mounting bracket 410 is configured for mounting on a support, as with the first support-mounting bracket 12. The box-mounting bracket 410 is fastened to the rear of the junction box 104, 104′ by fasteners 419 (e.g., screws) or in other ways. The box-mounting bracket 412 includes threaded holes, inserts, bosses or the like to which the screw threads 444 are threadably coupled. The screw threads 444 are rotatably coupled to and extend through the front plate of the support-mounting bracket 410 at a location outside of the junction box 104, 104′. The screw threads 444 do not translate relative to the support-mounting bracket 410. In use, the box-mounting bracket 412, and in turn the junction box 104, translates along the screw threads 444 in the forward-rearward direction relative to the support-mounting bracket 410 upon rotation of the screw threads. As shown in FIGS. 22, the mounting bracket 402 is configured for use with a second type of box 104′ (e.g., the octagonal box). As shown in FIG. 20, tongues 431 formed on the front plate of the support-mounting bracket 410 are pivotable about the front plate to increase the size of the opening 418 to accommodate the larger first box.

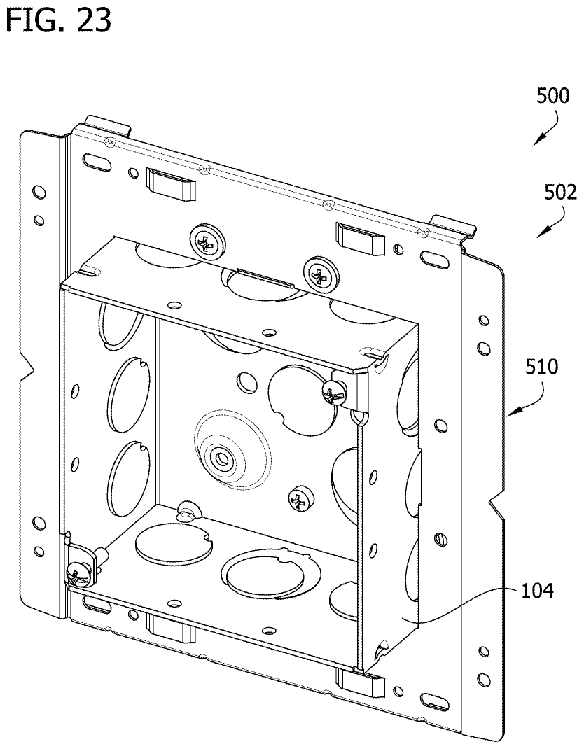

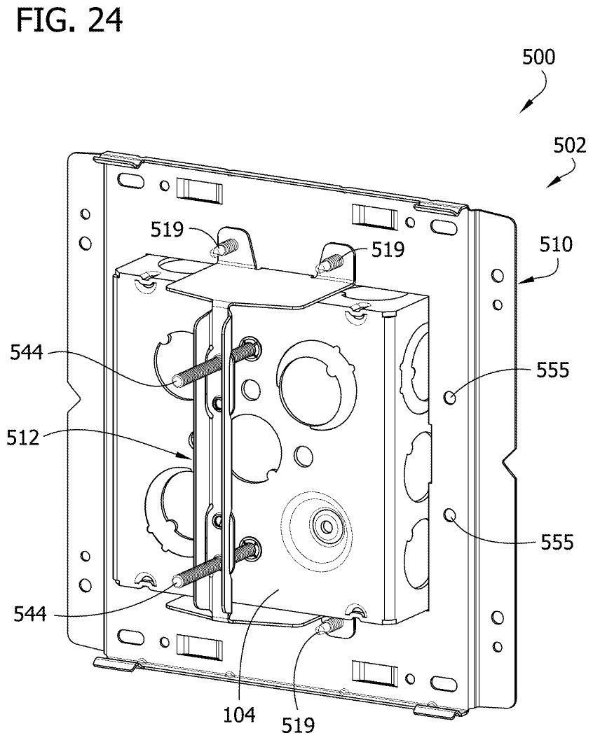

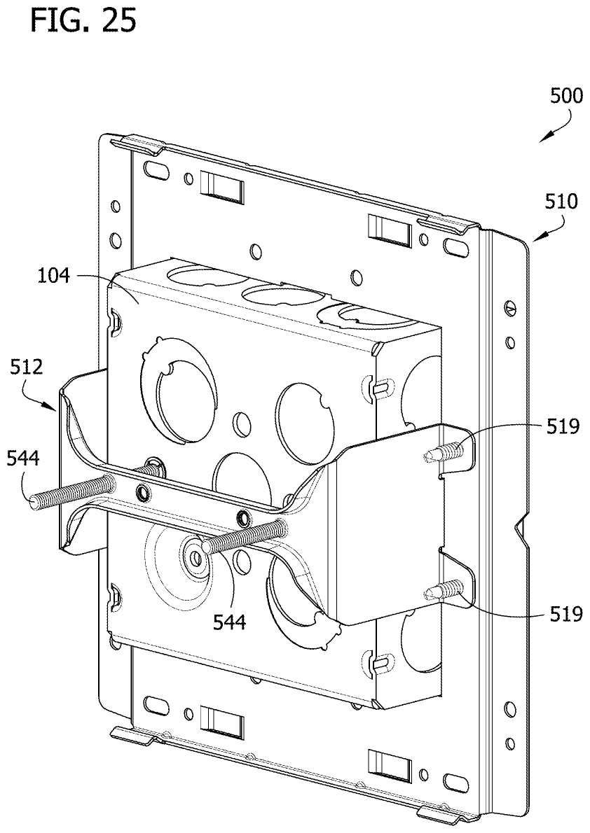

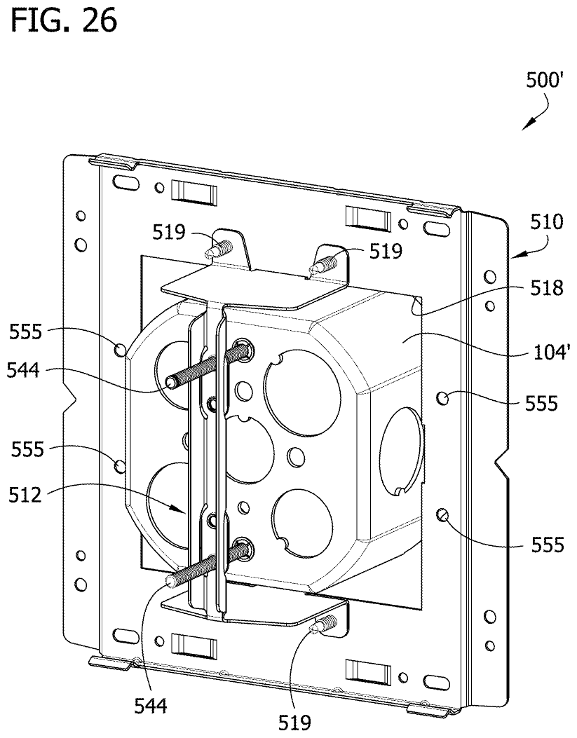

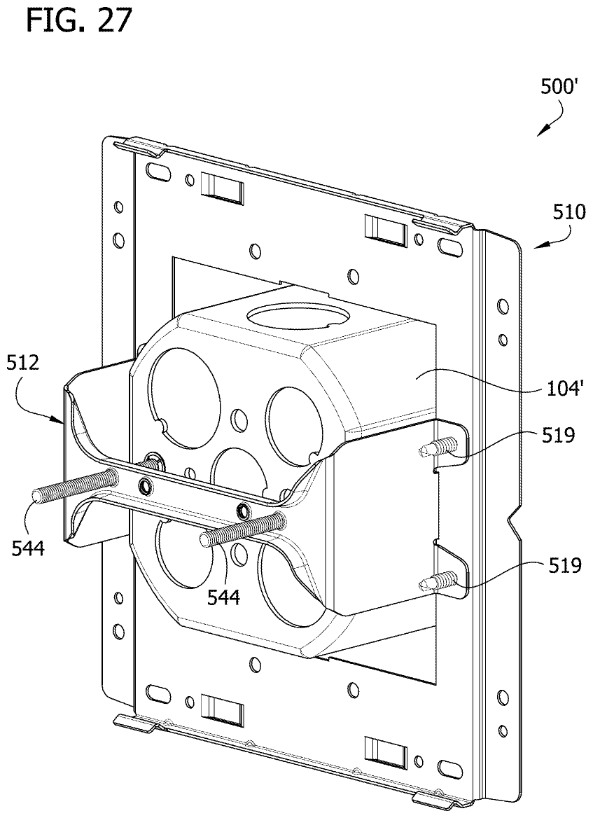

In a fifth embodiment of a box assembly 500 shown in FIGS. 23-27, a mounting bracket 502 includes a support-mounting bracket 510 and a box-mounting bracket 512 fastened to the support-mounting bracket by fasteners 519 (e.g., screws). The support-mounting bracket 510 is configured for mounting on a support, as with the first support-mounting bracket. The box-mounting bracket 512 is fastened to the rear of the junction box 104, 104′ by screw threads 544 or in other ways. The box-mounting bracket 512 includes threaded holes, inserts, bosses or the like to which the screw threads 544 are threadably coupled. The screw threads 544 are rotatably coupled to and extend through the rear side of the box. The screw threads 544 do not translate relative to the junction box 104, 104′. In use, the bracket 512, and in turn the box, translates along the screw threads in the forward-rearward direction upon rotation of the screw threads. As shown in FIGS. 26 and 27, the mounting bracket 502 is configured for use with a second type of box 104′ (e.g., the octagonal box). As can be seen in the drawings, the front plate includes a set of openings 555 on opposite sides of the box opening 518 such that the rotational position of the junction box 104, 104′ and the bracket 512 attached thereto can be adjusted to three other rotational positions relative to the front plate.

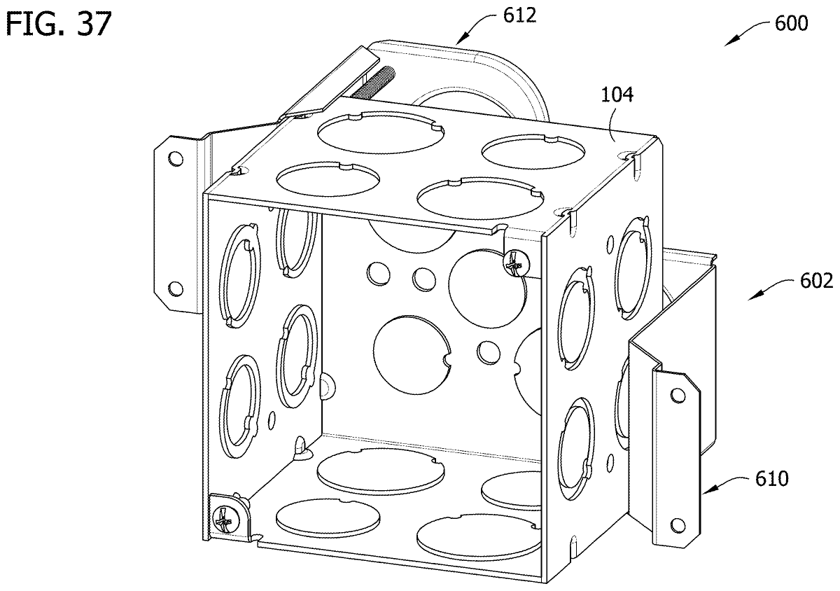

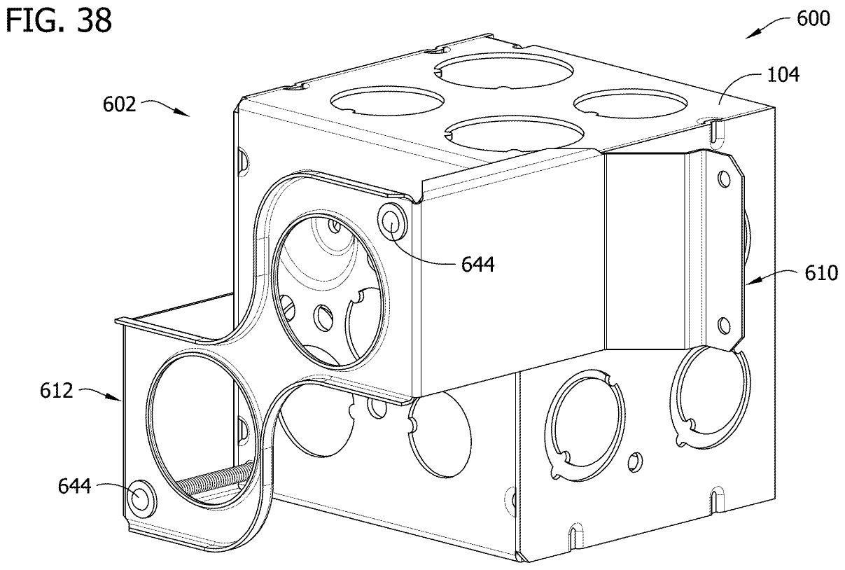

In a sixth embodiment of a box assembly 600 shown in FIGS. 37 and 38, a mounting bracket 602 includes a support-mounting bracket 610 and a box-mounting bracket 612 integrally formed as a one-piece component. In the illustrated embodiment, the support-mounting bracket includes mounting flanges. The box-mounting bracket includes threaded holes, inserts, bosses or the like to which the screw threads 644 are threadably coupled. The screw threads 644 are rotatably coupled to and extend through the rear side of the junction box 104. The screw threads 644 do not translate relative to the junction box 104. In use, the junction box 104 translates along the screw threads 644 in the forward-rearward direction upon rotation of the screw threads.

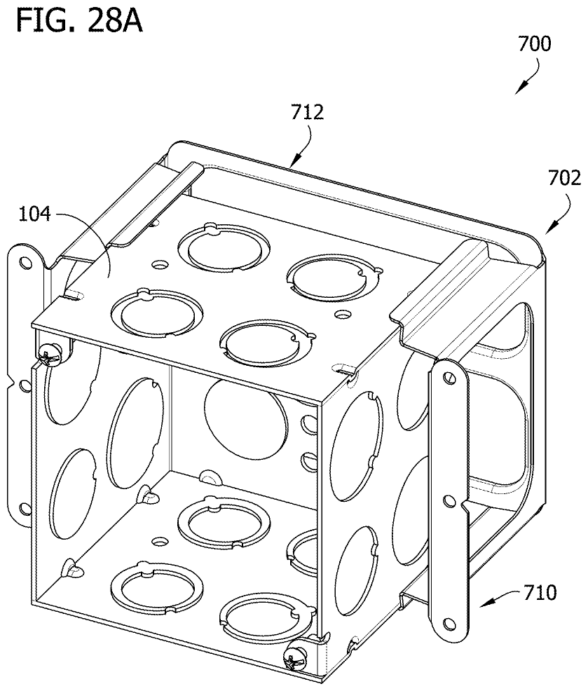

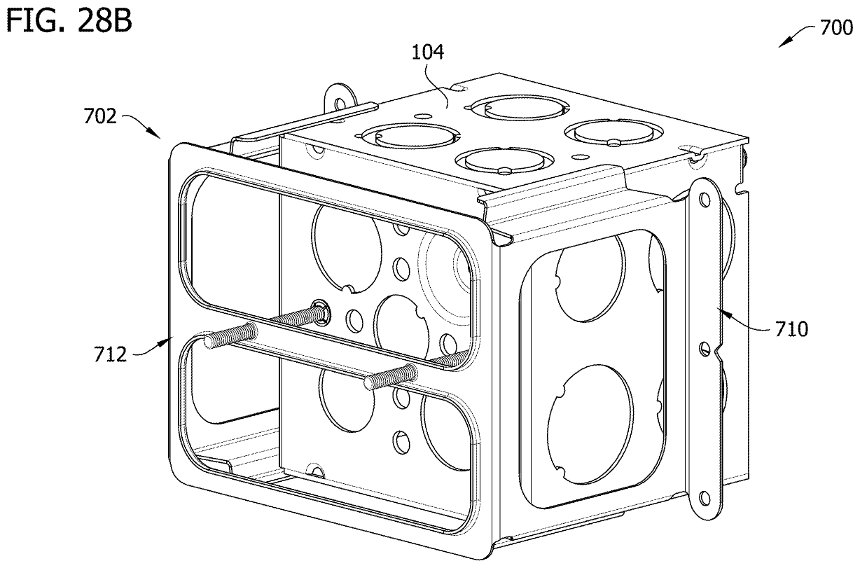

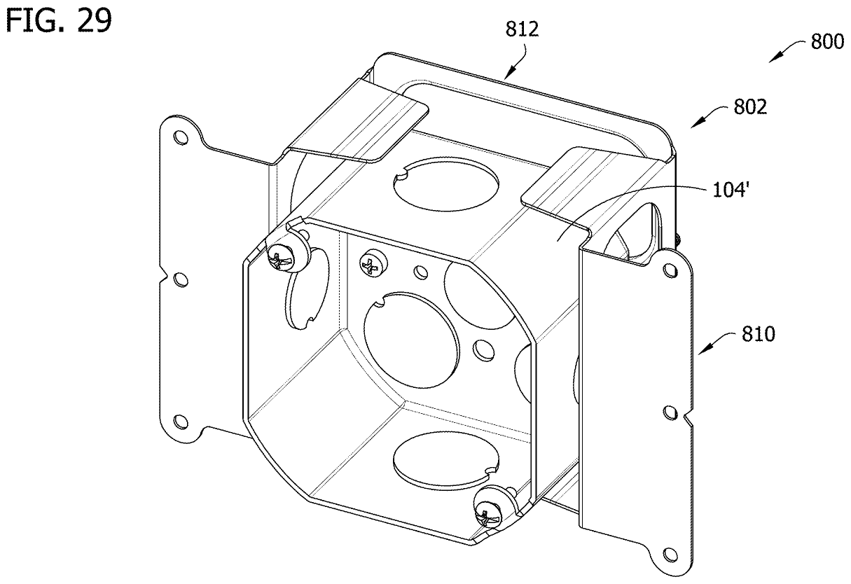

In a seventh embodiment of a box assembly 700 shown in FIGS. 28A and 28B, a mounting bracket 702 includes a support-mounting bracket 710 and a box-mounting bracket 712 integrally formed as a one-piece component. The support-mounting bracket 710 and the box-mounting bracket 712 are connected by integrally formed side walls. Screw threads similar to the prior embodiments are included. This mounting bracket 702 is configured (designed and constructed) for use with only the first type of box 104. In an eighth embodiment of a box assembly 800 shown in FIGS. 29 and 20, the mounting bracket 802 is configured (designed and constructed) for use with a second type of junction box 104′. The eighth embodiment of the box assembly 800 is similar to the box assembly 700 with reference numbers corresponding to similar features with plus 100.

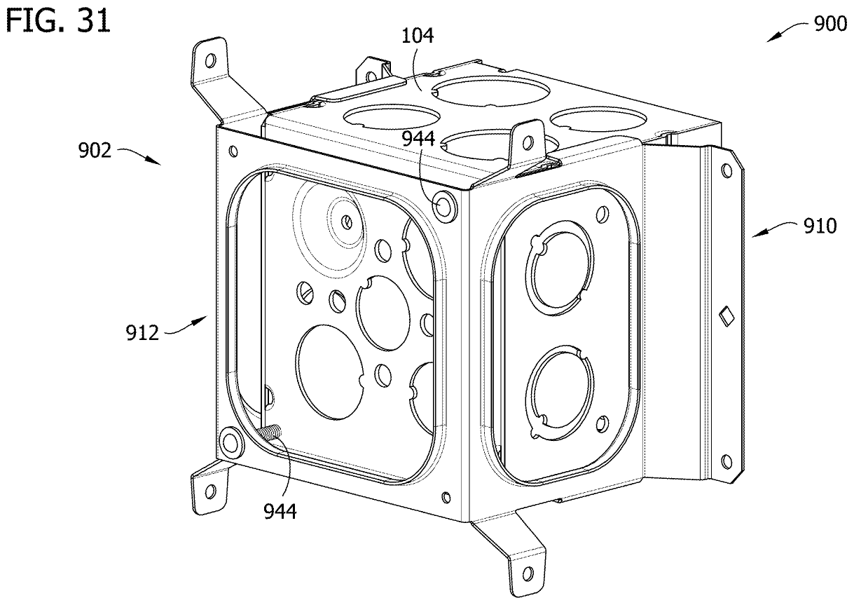

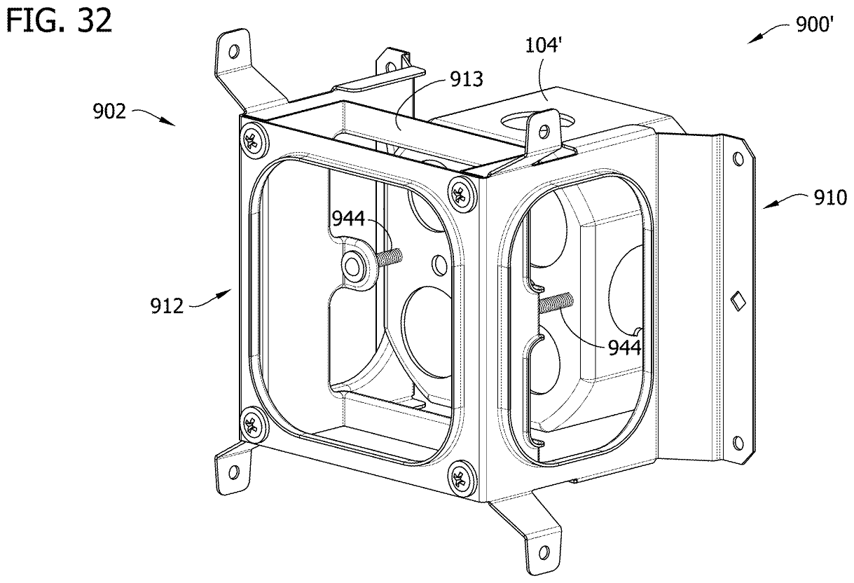

In a ninth embodiment of a box assembly 900, 900′ shown in FIGS. 31 and 32, a mounting bracket 902 is similar to the seventh embodiment except an adaptor 913 (FIG. 32) is configured (designed and constructed) for use with the second type of junction box 104′ to convert the mounting bracket from use with the first type of box (FIG. 31) to the second type of box. The adaptor 913 is selectively secured to the mounting bracket 902 to form a separate box-mounting bracket to which the screw threads of the second type of box are secured. In each configuration, the support-mounting bracket 910 is configured to be mounted on a structural support. In the illustrated embodiment, the screw threads 944 are mounted to the box-mounting bracket 912, 913 and the junction box 104, 104′ in the same way as described above with respect to the first box assembly.

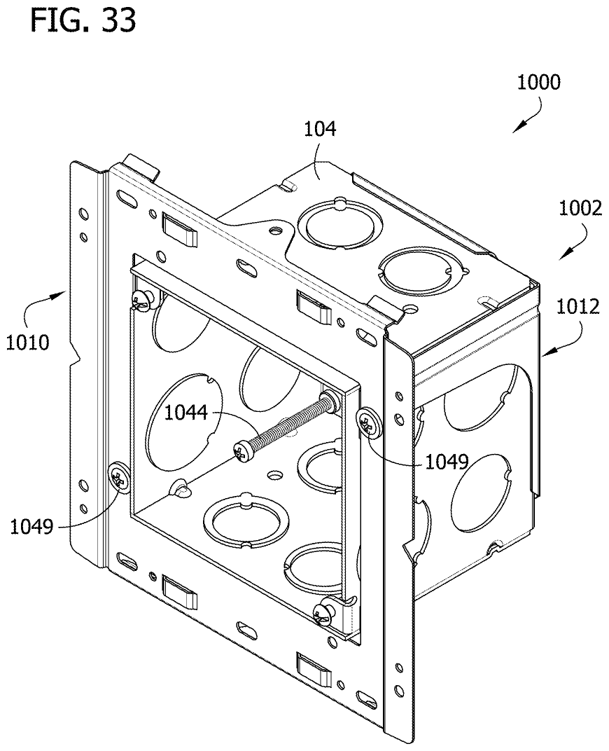

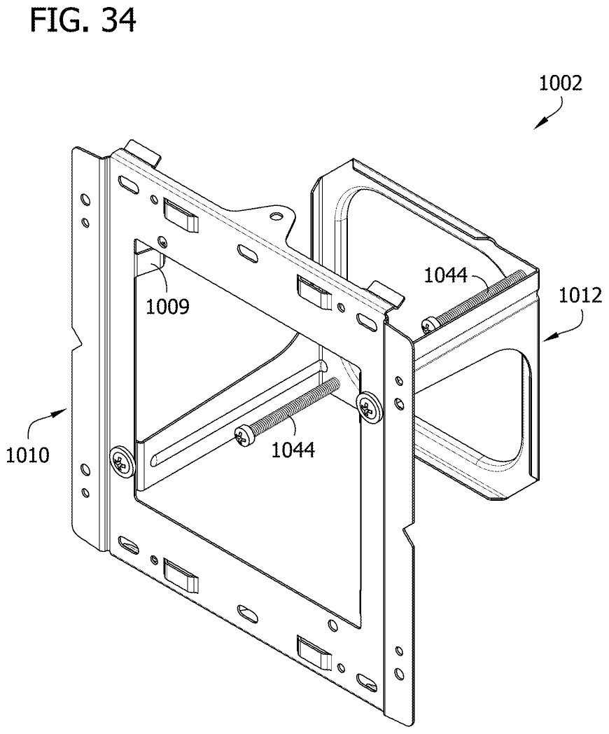

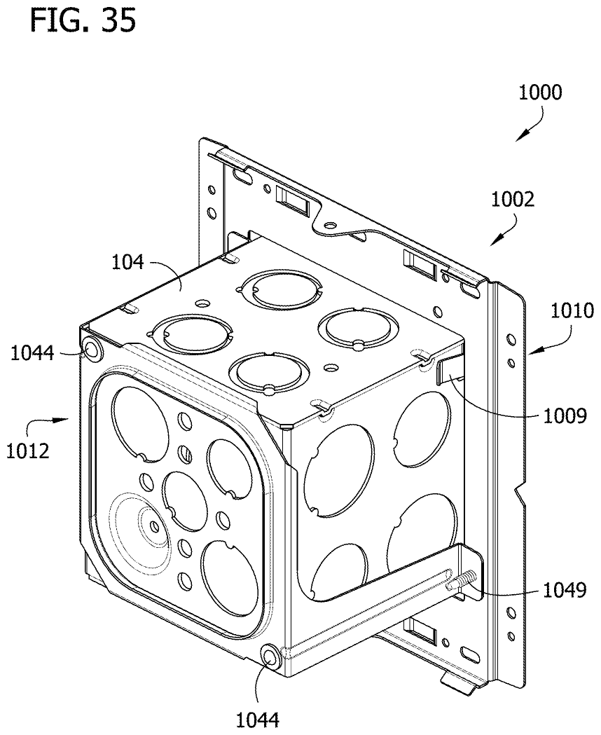

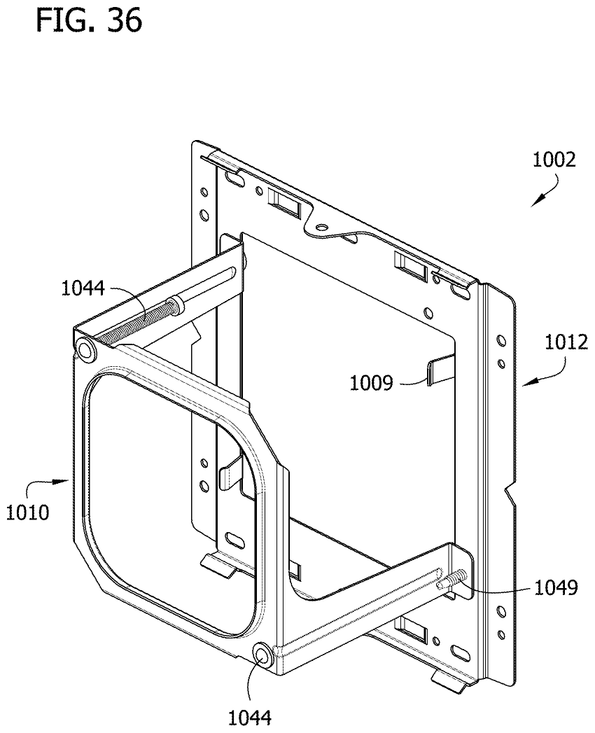

In a tenth embodiment of a box assembly 1000 shown in FIGS. 33-36, a mounting bracket 1002 includes a support-mounting bracket 1010 fastened to a box-mounting bracket 1012 by fastener(s) 1049. Screw threads 1044 rotatably secured to the box-mounting bracket secure the junction box 104 to the mounting bracket 1002 to allow the box to be translatable relative to the front of the support-mounting bracket 1010, as described in the first embodiment. In this embodiment, resiliently deflectable tabs 1009 are configured to engage the junction box 104 to make electrically contact therewith to ground the box.

The Modifications and variations of the disclosed embodiments are possible without departing from the scope of the invention defined in the appended claims.

When introducing elements of the present invention or the embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above constructions, products, and methods without departing from the scope of the invention, it is intended that all matter contained in the above description and shown in the accompanying drawings shall be interpreted as illustrative and not in a limiting sense.

What is claimed is:

1. An adjustable-depth junction box assembly comprising:
a junction box having a front face defining an opening;
a support-mounting bracket configured to be secured to a support structure to mount the adjustable-depth junction box assembly on the support structure, the support-mounting bracket having a front face defining an opening in which the junction box is received;
a box-mounting bracket connected to the support-mounting bracket and including a mounting portion spaced rearward of the front face of the support-mounting bracket; and
at least one screw thread extending through the junction box and rotatable coupled to the mounting portion of box-mounting bracket to secure the junction box to the box-mounting bracket, wherein the at least one screw thread is threadably coupled to the junction box such that rotation of the at least one screw thread imparts translation of the junction box relative to the support-mounting bracket to enable selective adjustment of the front face of the junction box relative to the front face of the support-mounting bracket.

2. The adjustable-depth junction box assembly of claim 1, wherein the support-mounting bracket and the box-mounting bracket comprises mateable connectors configured to connect the box-mounting bracket to the support-mounting bracket.

3. The adjustable-depth junction box assembly of claim 2, wherein the mateable connector of the box-mounting bracket comprises a connector leg extending generally orthogonally from at least two sides of mounting portion of the box-mounting bracket and the mateable connector of the support-mounting bracket comprises first and second connector legs extending rearward from the front face on either side of the opening defined by the front face of the support-mounting bracket.

4. The adjustable-depth junction box assembly of claim 3, wherein one of (i) the connector legs of the box-mounting bracket, and (ii) one the connector legs of support-mounting bracket includes a locking tab, wherein the other of (i) the connector legs of the box-mounting bracket, and (ii) one the connector legs of support-mounting bracket defines a slot configured to receive the locking tab.

5. The adjustable-depth junction box assembly of claim 4, wherein the connector legs that defines the slot further defines a locking opening adjacent the slot, wherein the connector legs include the locking tab further include a catch extending from the locking tab, wherein the locking tab and catch form a snap-fit connection with the slot and the locking opening, respectively.

6. The adjustable-depth junction box assembly of claim 3, wherein the connector legs of the support-mounting bracket are configured to bend inwards at lines of weaknesses.

7. The adjustable-depth junction box assembly of claim 3, wherein at least one of the connector legs of support-mounting bracket or the connector legs of the box-mounting bracket comprise longitudinal ribs configured to provide rigidity.

8. The adjustable-depth junction box assembly of claim 2, wherein the mateable connector of the box-mounting bracket comprises the connector legs extending generally orthogonally from four sides of the mounting portion, wherein a first pair of the connector legs of the box-mounting bracket are connected to the support-mounting bracket as a first configuration, wherein a second pair of the connector legs of the box-mounting bracket are connected to the support-mounting bracket as a second configuration.

9. The adjustable-depth junction box assembly of claim 1, wherein the support-mounting bracket comprises first and second snap-arms extending from first and second ends of the front face, the first and second snap-arms being configured to secure the support-mounting bracket to a stud-mounting bracket.

10. The adjustable-depth junction box assembly of claim 1, wherein the support-mounting bracket comprises first and second tabs extending rearward and being configured to secure the support mounting bracket to the support structure.

11. The adjustable-depth junction box assembly of claim 1, wherein the mounting portion of the box-mounting bracket defines an opening configured to access a rear portion of the junction box.

12. The adjustable-depth junction box assembly of claim 1, wherein the screw thread extends through and rearward from a back portion of the junction box such that a head of the screw thread is received in an interior portion of the junction box.

13. The adjustable-depth junction box assembly of claim 1, further comprising a threaded nut or boss on a back portion of the junction box to enable threaded attachment of the screw thread.

14. The adjustable-depth junction box assembly of claim 1, wherein the box-mounting bracket comprises a rear plate with diagonally opposite openings, wherein the screw threads are rotatably coupled to the rear plate at diagonally opposite openings.

15. The adjustable-depth junction box assembly of claim 1, wherein the support-mounting bracket comprises pivotable tongues attached to the front face adjacent the opening defined by the front face to increase the size of the opening defined by the front face.

16. The adjustable-depth junction box assembly of claim 1, wherein the front face of the support-mounting bracket defines mounting openings for securing the mounting portion of the box-mounting bracket to the support-mounting bracket, wherein the mounting openings are adjacent the opening defined by the front face.

17. The adjustable-depth junction box assembly of claim 1, wherein the support-mounting bracket comprises resiliently deflectable tabs extending rearward into the opening defined by the front face, wherein the resiliently deflectable tabs are configured to engage the junction box to ground the junction box.

18. The adjustable-depth junction box assembly of claim 1, wherein the box-mounting bracket and the support-mounting bracket are integrally formed.

19. A box-mounting bracket assembly for a support-mounting bracket having a front face defining an opening for receiving a junction box, the box-mounting bracket assembly comprising:
a junction box having a front face defining an opening;
a box-mounting bracket including a mounting portion and configured to be selectively attached to the support-mounting bracket so that the mounting portion is spaced rearward of the front face of the support-mounting bracket; and
at least one screw thread extending through the junction box and rotatable coupled to the box-mounting bracket to secure the junction box to the box-mounting bracket, wherein the at least one screw thread is threadably coupled to the junction box such that rotation of the at least one screw thread imparts translation of the junction box relative to the mounting portion of the box-mounting bracket.

20. An adjustable-depth junction box assembly comprising:
a junction box having a front face defining an opening;
a support-mounting bracket configured to be secured to a support structure to mount the adjustable-depth junction box assembly on the support structure, the support-mounting bracket defining an opening in which the junction box is received;
a box-mounting bracket integrally formed to the support-mounting bracket and comprising a mounting portion; and
at least one screw thread extending through the junction box and rotatable coupled to the mounting portion of box-mounting bracket to secure the junction box to the box-mounting bracket, wherein the at least one screw thread is threadably coupled to the junction box such that rotation of the at least one screw thread imparts translation of the junction box in a forward or rearward direction.
